(19) United States
(12) Patent Application Publication
(10) Pub. No.: US 2006/0020480 A1
(43) Pub. Date: Jan. 26, 2006

(54) Method for offering deeds to famous locations

(76) Inventor: Brent Hickey, Phoenix, AZ (US)

Correspondence Address: WEISS & MOY PC, 4204 NORTH BROWN AVENUE, SCOTTSDALE, AZ, 85251, US

(21) Appl. No.: 10/897,218

(22) Filed: Jul. 22, 2004

(51) Int. Cl. G06Q 99/00

(52) U.S. Cl. 705/1

(57) ABSTRACT

A method for generating income for a famous landmark first divides the famous landmark into a plurality of parcels. A novelty deed is created for each of the parcels. The novelty deeds are then sold for a predetermined amount of money.

### BACKGROUND OF THE INVENTION

1. Field of the Invention

This invention relates to land ownership and, more specifically, to a method of generating income by selling deeds to small pieces of famous locations.

2. Description of the Prior Art

Municipalities have always had a difficult time in raising revenues without increasing taxes or increasing fees for different services that are provided. Presently, many municipalities are operating at a shortfall with expenditures far exceeding income. Because of this, many municipalities have raised taxes and cut services in order to balance their budget. Because of these budget cuts, many national parks, monuments, land marks, etc., have had services cut. Maintaining these national parks, monuments, land marks, etc. has become a problem because of these cuts.

When visiting the national parks, monuments, land marks, etc., many people like to buy souvenirs. These souvenirs may be a t-shirt, coffee mug, magnet, etc., which will have a picture or the name of the site printed thereon. While these items are nice, there isn't any real novelty or uniqueness to these gifts. Furthermore, very little of the money spent on these souvenirs actually goes back to the municipalities so that the municipalities can continue to provide services and maintenance at the site.

Therefore, there is a need for a method of generating income for municipalities that overcomes the above problems. Furthermore, there is a need for a device and method that allows a person to purchase a part of a famous site. The device and method allowing municipalities to generate income to maintain the site.

### SUMMARY OF THE INVENTION

In accordance with one embodiment of the present invention, it is an object of the present invention to provide a method of generating income for municipalities that overcomes the problems associated with prior art methods.

It is another object of the present invention to provide a device and method that allows a person to purchase a part of a famous site.

It is another object of the present invention to provide a device and method that allows a person to purchase a part of a famous site thereby allowing municipalities to generate income to maintain the site.

### BRIEF DESCRIPTION OF THE EMBODIMENTS

In accordance with one embodiment of the present invention a method for generating income for a famous landmark is disclosed. The method comprises: dividing the famous landmark into a plurality of parcels; creating a novelty deed for each of the parcels; and selling the novelty deeds for a predetermined amount of money.

In accordance with another embodiment of the present invention, a method for generating an annual income for a famous landmark is disclosed. The method comprises: dividing the famous landmark into a plurality of parcels; creating a novelty deed for each of the parcels; and selling the novelty deeds for a predetermined amount of money, wherein the novelty deeds are valid for one year.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a flow chart showing the method of the present invention.

### DETAILED DESCRIPTION OF THE PREFERRED EMBODIMENT

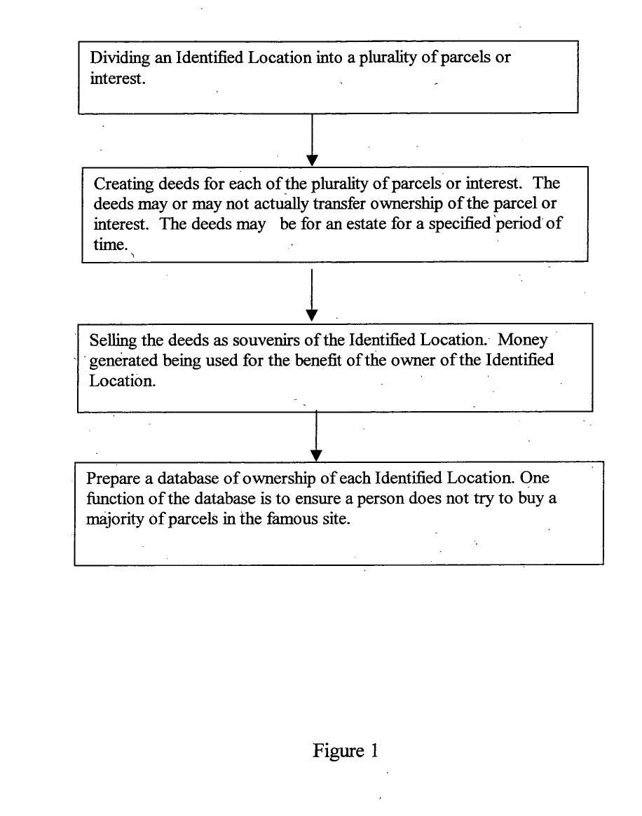

Referring to FIG. 1, a method is disclosed which will allow municipalities and owners of famous sites and landmarks to generate income to allow the municipality/owner of the site to perform maintenance and upkeep of the site and for the benefit of the owner. Thus, the municipality/owner of the site will not have to raise admission fees, taxes, etc. to generate additional income to perform these services.

The method will work for unimproved or improved land sites. Thus, the method will work for unimproved sites such as the Grand Canyon, Old Faithful, Wakiki Beach as well as improved sites like Wrigley Field, Yankee Stadium, Empire State Building, etc. The method allows the owner of the site to offer novelty deeds to the site so that a person can own a part of the site.

The method works in the following manner. The site is divided into a plurality of small parcels or interest. For example, the site may be divided into sections 1″×1″, 1′×1′, or the like. The dimensions given above are given as an example and should not be seen as to limit the scope of the present invention. A survey of the site may be done so that the actual location of each parcel can be recorded. Additionally, the site may be separated into undivided 1/10,000 interest, 1/100,000 interest, or the like. Again, the percent interest is given as an example and should not be seen as to limit the scope of the present invention.

A deed for each parcel or interest is then prepared. The deed would be a novelty deed. Each novelty deed is then sold to different individuals. The novelty deeds can be used as gifts, souvenirs, etc. Each novelty deed can be sold for a certain dollar amount. The novelty deed may be valid for six months, one year, or more. If the novelty deed is good for only one year or less, this would allow the municipality/owner to raise money annually by selling the novelty deeds.

The municipality/owner has two options when selling the novelty deeds. In the first option, no actual transfer of ownership of the parcel/interest is done. Language may be written in the deed to let the purchaser know that they have no actual ownership rights to the parcel. The person buying the novelty deed may be given certain privileges/rights to the parcel, but no actual ownership rights are being sold. Furthermore, certain legal language may be written on the novelty deed to prevent the buyer from trying to hinder the municipality/owner from showing/using the site. In the second option, the novelty deeds sold actually convey ownership rights if the municipality/owner desires. Again, certain legal language may be written on the novelty deed to prevent the buyer from trying to hinder the municipality/owner from showing/using the site. Other language may also be in the novelty deed to prevent the person buying the novelty deed from selling/leasing the parcel/interest or for preventing individuals from trying to proxy their rights to form a majority. Furthermore, records of purchases should be kept to prevent individuals from trying to purchase a majority of parcels.

The money raised from the sale of the novelty deeds may be used in a variety of ways. All of which are for the improvement of the site. If the site is an unimproved land area, the money may be used for land improvement. For example, a park, landscaping, recreational use, or other improvements for the benefit of the owner. Money may be used to maintain the site. If the site is already improved, the money may be used for maintenance, charitable purposes, or any other purpose at the direction of the owner.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for generating income for a famous landmark comprising:
dividing the famous landmark into a plurality of parcels;
creating a novelty deed for each of the parcels; and
selling the novelty deeds for a predetermined amount of money.

2. The method of claim 1, further comprising surveying the famous landmark to divide the famous landmark into a plurality of parcels.

3. The method of claim 1, wherein the novelty deeds do not convey an actual ownership right to the parcel.

4. The method of claim 1, wherein the novelty deeds convey an actual ownership right to the parcel.

5. The method of claim 1, wherein the novelty deeds are valid for a predetermined time frame.

6. A method for generating income for a famous landmark comprising:
surveying the famous landmark to divide the famous landmark into a plurality of parcels;
dividing the famous landmark into a plurality of parcels;
creating a novelty deed for each of the parcels; and
selling the novelty deeds for a predetermined amount of money as a souvenir of the famous landmark so an individual may own a small section of the famous landmark.

7. The method of claim 1, wherein the novelty deeds are valid for a predetermined time frame.

8. A method for generating income for a famous landmark comprising:
dividing the famous landmark into a plurality of interests;
creating a novelty deed for each of the plurality of interests; and
selling the novelty deeds for a predetermined amount of money.

9. The method of claim 8, wherein the novelty deeds do not convey an actual ownership right.

10. The method of claim 8, wherein the novelty deeds convey an actual ownership right.

11. The method of claim 8, wherein the novelty deeds are valid for a predetermined time frame.

12. A method for generating annual income for a famous landmark comprising:
dividing the famous landmark into a plurality of parcels;
creating a novelty deed for each of the parcels; and
selling the novelty deeds for a predetermined amount of money, wherein the novelty deeds are valid for one year.

13. The method of claim 12, further comprising surveying the famous landmark to divide the famous landmark into a plurality of parcels.

14. The method of claim 12, wherein the novelty deeds do not convey an actual ownership right to the parcel.

15. The method of claim 12, wherein the novelty deeds convey an actual ownership right to the parcel.
